(19) United States
(12) Patent Application Publication
(10) Pub. No.: US 2005/0204091 A1
(43) Pub. Date: Sep. 15, 2005

(54) Non-volatile memory with synchronous DRAM interface

(76) Inventors: Kevin M. Kilbuck, Boise, ID (US); David Eggleston, San Jose, CA (US)

Correspondence Address: LEFFERT JAY & POLGLAZE, P.A., P.O. BOX 581009, MINNEAPOLIS, MN, 55458-1009, US

(21) Appl. No.: 10/798,795

(22) Filed: Mar. 11, 2004

(51) Int. Cl. G06F 12/00

(52) U.S. Cl. 711/103

(57) ABSTRACT

A high density non-volatile memory system, card, and device is described that incorporates a synchronous interface. This is accomplished through use of an external or embedded controller and/or memory buffer to manage the high density non-volatile memory device(s) to present it as a conventional memory device having a synchronous interface that is accessible by row and column address. This allows the high density non-volatile memory to support in-place code execution and allows it to be booted from. Additionally, this incorporation eliminates the overhead of drivers and/or operating system support required to utilize and present conventional high density non-volatile memory devices and moves it internal to the memory device. This simplifies the use and design effort in the overhead and specialized interfacing of high density non-volatile memories and in particular, NAND architecture Flash memories, while reducing the production cost through use of less expensive high density non-volatile memory.

### TECHNICAL FIELD OF THE INVENTION

The present invention relates generally to memory devices and in particular the present invention relates to non-volatile memory devices with synchronous interfaces.

### BACKGROUND OF THE INVENTION

Memory devices are typically provided as internal storage areas in a computer. The term memory identifies data storage that comes in the form of integrated circuit chips. There are several different types of memory used in modern electronics, one common type is RAM (random-access memory). RAM is characteristically found in use as main memory in a computer environment. RAM refers to read and write memory; that is, you can both write data into RAM and read data from RAM. This is in contrast to ROM (read-only memory), which permits you only to read data. Most RAM is volatile, which means that it requires a steady flow of electricity to maintain its contents.

Computers almost always contain a small amount of ROM that holds instructions for starting up the computer, typically called a basic input output system (BIOS). Unlike RAM, ROM generally cannot be written to by a user. An EEPROM (electrically erasable programmable read-only memory) is a special type of non-volatile ROM that can be erased and programmed by exposing it to an electrical charge. EEPROM comprise a large number of memory cells having electrically isolated gates (floating gates). Data is stored in the memory cells in the form of charge on the floating gates. Charge is transported to or removed from the floating gates by specialized programming and erase operations.

Yet another type of non-volatile memory is a Flash memory. A Flash memory is a type of EEPROM that can be erased and reprogrammed in blocks instead of one byte at a time. A typical Flash memory comprises a memory array, which includes a large number of memory cells. Each of the memory cells includes a floating gate field-effect transistor capable of holding a charge. The data in a cell is determined by the presence or absence of the charge in the floating gate. The cells are usually grouped into sections called “erase blocks.” The memory cells of a Flash memory array are typically arranged into a “NOR” architecture (each cell directly coupled to a bitline) or a “NAND” architecture (cells coupled into “strings” of cells, such that each cell is coupled indirectly to a bitline and requires activating the other cells of the string for access, but allowing for a higher cell density). Each of the cells within an erase block can be electrically programmed in a random basis by charging the floating gate. The charge can be removed from the floating gate by a block erase operation, wherein all floating gate memory cells in the erase block are erased in a single operation.

A problem with NAND Flash memory is that with its higher density and configuration it requires specialized interfacing and interaction to utilize; many available processors and memory controllers do not directly support NAND Flash memory whereas NOR Flash memory support is more commonly available. Typically this means that a majority of the control and management of a NAND Flash memory device is external from the memory device and in expensive dedicated hardware or a software driver that is executed on a coupled memory controller or processor. In addition, as multiple floating gate memory cell transistors are coupled together in the strings of a NAND Flash memory array, individual errors in the array are more difficult to correct for than in NOR Flash memory. This issue becomes even more of a problem when multi-level memory cells (MLCs), which store multiple memory states in each cell, are utilized. To compensate for this and to take advantage of the inherent higher array density, NAND Flash memory typically utilizes error correction codes (ECC) and/or are interfaced to and presented as a mass storage device, such as a magnetic disk. In this manner the errors of a NAND Flash memory device can be addressed by the operating system/host/driver/firmware and/or the file system that the Flash device is formatted with. In addition, wear leveling routines are also typically incorporated in the interface/drivers for NAND Flash memory device(s) to distribute writes and help prevent early wear out of the device(s). However, NAND architecture Flash memory devices are also generally less expensive and of larger capacity than a corresponding NOR architecture Flash memory device, making them desirable for system designers.

As NAND architecture Flash memories are of higher array density they generally have slower initial data access times and typically are arranged to transfer large blocks of data with each access request. These features make the use of NAND architecture Flash memories for large numbers of non-sequential individual data word accesses prohibitive. Because of this code and data are typically copied from a NAND architecture Flash memory device into a RAM memory and then executed. Code execution is more readily accomplished with NOR architecture Flash memory devices, which contain a more conventional array structure and transfer smaller data blocks on each access, allowing them to be booted/executed from. It is noted that other types of high density non-volatile memory that share many of the characteristics of NAND architecture Flash (slow access speeds, large data volume, non-standardized interfacing and drivers, etc.) including, but not limited to, Polymer Memory, Ferroelectric Random Access Memory (FeRAM), Ovionics Unified Memory (OUM), Magnetoresistive Random Access Memory (MRAM), Molecular Memory, and Carbon Nanotube Memory are also known.

A synchronous DRAM (SDRAM) is a type of DRAM that can run at much higher clock speeds than conventional DRAM memory. SDRAM's can be accessed quickly, but are volatile. SDRAM synchronizes itself with a CPU's bus and is capable of running at 100 MHZ, 133 MHZ, 166 MHZ, or 200 MHZ, about three or four times faster than conventional FPM (Fast Page Mode) RAM, and about two to three times as fast EDO (Extended Data Output) DRAM and BEDO (Burst Extended Data Output) DRAM. An extended form of SDRAM that can transfer a data value on the rising and falling edge of the clock signal is called double data rate SDRAM (DDR SDRAM, or simply, DDR). Other forms of synchronous memory interfaces are also utilized in modern memories and memory systems, including, but not limited to, double data rate 2 SDRAM (DDR2), graphics double data rate (GDDR), graphics double data rate 2 (GDDR2), and Rambus DRAM (RDRAM).

Many computer systems are designed to operate using one or more forms of synchronous DRAM, but would benefit from non-volatile memory. A synchronous NOR Flash memory has been designed that allows for a non-volatile memory device with an SDRAM interface. Although knowledge of the function and internal structure of a synchronous NOR Flash memory is not essential to understanding the present invention, a detailed discussion is included in U.S. patent application Ser. No. 09/627,682 filed Jul. 28, 2000 and titled, “Synchronous Flash Memory.”

For the reasons stated above, and for other reasons stated below which will become apparent to those skilled in the art upon reading and understanding the present specification, there is a need in the art for a synchronous non-volatile memory device or subsystem, in particular one that has an SDRAM or DDR compatible interface and allows for in-place code execution and/or can be used to boot from.

### SUMMARY

The above-mentioned problems with non-volatile memories, in-place code execution, synchronous memory interfaces, and other problems are addressed by the present invention and will be understood by reading and studying the following specification.

Although described in relation to NAND architecture Flash memory, the various embodiments relate generally to non-volatile memory devices and subsystems that incorporate a synchronous interface. Memory device embodiments of the present invention utilize an external or embedded controller and/or memory buffer to present the non-volatile memory device(s) as a conventional memory device having a synchronous interface. This allows the non-volatile memory embodiments of the present invention to support in-place code execution and allow them to be booted from. Additionally, the memory buffer allows for caching/buffering of data read and/or write accesses, allowing non-volatile memory devices of the present invention to be quickly accessed as if they were conventional synchronous RAM memory devices.

In one embodiment of the present invention, a non-volatile memory device eliminates the requirement of external drivers, customized NAND interface port on a memory controller or microprocessor, and/or operating system support to utilize a specialized high density non-volatile memory device, and in particular, a NAND architecture Flash memory device. This simplifies the use and design effort of high density non-volatile memories by reducing specialized interfacing, while reducing the overall production cost through allowing use of a less expensive NAND architecture Flash memory or other high density non-volatile memory where a more expensive memory device would normally be required. In another embodiment of the present invention, a NAND architecture Flash card or subsystem has a synchronous interface. In a further embodiment of the present invention, a NAND architecture Flash memory device, card, or subsystem has an SDRAM compatible interface. In yet a further embodiment of the present invention, individual data words of a NAND architecture Flash memory device, card, or subsystem may be accessed in a non-prohibitive manner. In another embodiment of the present invention, a NAND architecture Flash memory device, card, or subsystem is accessed by a row and column address. In yet another embodiment of the present invention, a NAND architecture Flash memory device, card, or subsystem contains a RAM buffer allowing in-place code execution and/or read/write access.

For one embodiment, the invention provides a non-volatile memory device comprising a non-volatile memory array, a buffer memory, a synchronous memory interface, and a controller coupled to the non-volatile memory array, the buffer memory, and the synchronous memory interface, wherein the controller is adapted to interface to and manage the non-volatile memory array and buffer memory and to present the non-volatile memory device as a synchronous memory device through the synchronous memory interface.

For another embodiment, the invention provides a NAND architecture Flash memory device comprising a NAND architecture Flash memory array a buffer memory, a synchronous memory interface, and a controller coupled to the NAND architecture Flash memory array, the buffer memory, and the synchronous memory interface, wherein the controller is adapted to interface to and manage the NAND architecture Flash memory array and to portray the NAND architecture Flash memory device as a synchronous memory device through the synchronous memory interface.

For yet another embodiment, the invention provides a non-volatile memory subsystem comprising one or more non-volatile memory devices, a buffer memory, a synchronous memory interface, and a controller coupled to the one or more non-volatile memory devices, the buffer memory, and the synchronous memory interface, wherein the controller is adapted to interface to and manage the non-volatile memory devices and to present the non-volatile memory devices as a synchronous memory device through the synchronous memory interface.

For a further embodiment, the invention provides a system comprising a host and one or more non-volatile memory devices coupled to the host. Each of the one or more non-volatile memory devices comprising a non-volatile memory array, a buffer memory, a synchronous memory interface, and a controller coupled to the non-volatile memory array, the buffer memory, and the synchronous memory interface, wherein the controller is adapted to interface to and manage the non-volatile memory array and to present the non-volatile memory device as a synchronous memory device through the synchronous memory interface.

For yet a further embodiment, the invention provides a method of operating a non-volatile memory device comprising managing the non-volatile memory device with an internal controller presenting the non-volatile memory device as a synchronous memory device through a synchronous memory interface, and buffering data access requests received through the synchronous memory interface in an internal buffer memory.

Further embodiments of the invention include methods and apparatus of varying scope.

### BRIEF DESCRIPTION OF THE DRAWINGS

FIG. 1 is a simplified block diagram of a system containing a Flash memory device in accordance with an embodiment of the present invention.

FIG. 2 is a simplified block diagram of a system containing a Flash memory device in accordance with another embodiment of the present invention.

FIGS. 3A and 3B are simplified block diagrams of systems containing a Flash memory subsystem in accordance with yet another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

Although described in relation to NAND architecture Flash memory, the various embodiments relate generally to non-volatile memory devices and subsystems that incorporate a synchronous interface. High density non-volatile memory subsystems and devices of the present invention incorporate a synchronous interface to allow them to be utilized as a conventional memory device. Memory device embodiments of the present invention utilize an external or embedded controller and/or memory buffer to present the high density non-volatile memory device(s) as a conventional memory device having a synchronous interface. This allows the high density non-volatile memory embodiments of the present invention to support in-place code execution and allow them to be booted from. Additionally, the memory buffer allows for caching/buffering of data read and/or write accesses, allowing high density non-volatile memory devices of the present invention to be quickly accessed as if they were conventional synchronous RAM memory devices. In one embodiment of the present invention, a high density non-volatile memory device eliminates the requirement of external drivers, a memory controller, a customized interface port on a microprocessor, and/or operating system support to utilize a specialized high density non-volatile memory device, and in particular, a NAND architecture Flash memory device. This simplifies the use and design effort of high density non-volatile memories by reducing specialized interfacing, while reducing the overall production cost through allowing use of a less expensive NAND architecture Flash memory or other high density non-volatile memory where a more expensive memory device would normally be required. In another embodiment of the present invention, a NAND architecture Flash card or subsystem has a synchronous interface. In a further embodiment of the present invention, a NAND architecture Flash memory device, card, or subsystem has an SDRAM compatible interface. In yet a further embodiment of the present invention, individual data words of a NAND architecture Flash memory device, card, or subsystem may be accessed in a non-prohibitive manner. In another embodiment of the present invention, a NAND architecture Flash memory device, card, or subsystem is accessed by a row and column address. In yet another embodiment of the present invention, a NAND architecture Flash memory device, card, or subsystem contains a RAM buffer allowing in-place code execution and/or read/write access. In yet a further embodiment, to reduce average access time, a burst mode access has been implemented. The burst mode uses an internal column address counter circuit to generate additional column addresses. The address counter begins at an externally provided address and advances in response to an external clock signal or a column address strobe signal, up to a selected page size limit.

As stated above, the two common types of Flash memory array architectures are the “NAND” and “NOR” architectures, so called for the similarity each basic memory cell configuration has to the corresponding logic gate design. Both NAND and NOR Flash memory devices have memory cells that are typically arranged in an array of rows and columns. In NAND Flash memory devices and some NOR Flash memory devices, a row (page) is accessed and then memory cells can be randomly accessed on the page by providing column addresses. This access mode is referred to as page mode access. To read or write to multiple column locations on a page requires the external application of multiple column addresses.

In the NOR array architecture, the floating gate memory cells of the memory array are arranged in a matrix similar to RAM or ROM. The gates of each floating gate memory cell of the array matrix are coupled by rows to word select lines (word lines) and their drains are coupled to column bit lines. The source of each floating gate memory cell is typically coupled to a common source line. The NOR architecture floating gate memory array is accessed by a row decoder activating a row of floating gate memory cells by selecting the word line coupled to their gates. The row of selected memory cells then place their stored data values on the column bit lines by flowing a differing current if in a programmed state or not programmed state from the coupled source line to the coupled column bit lines. A column page of bit lines is selected and sensed, and individual data words are selected from the sensed data words from the column page and communicated from the Flash memory.

A NAND array architecture also arranges its array of floating gate memory cells in a matrix such that the gates of each floating gate memory cell of the array are coupled by rows to word lines. However each memory cell is not directly coupled to a source line and a column bit line. Instead, the memory cells of the array are arranged together in strings, typically of 16, 32, or more each, where the memory cells in the string are coupled together in series, source to drain, between a common source line and a column bit line. This allows a NAND Flash array architecture to have a higher memory cell density than a comparable NOR Flash array, but with the cost of a generally slower access rate and programming complexity.

A NAND architecture floating gate memory array is accessed by a row decoder activating a row of floating gate memory cells by selecting the word select line coupled to their gates. In addition, the word lines coupled to the gates of the unselected memory cells of each string are also driven. However, the unselected memory cells of each string are typically driven by a higher gate voltage so as to operate them as pass transistors and allowing them to pass current in a manner that is unrestricted by their stored data values. Current then flows from the source line to the column bit line through each floating gate memory cell of the series coupled string, restricted only by the memory cells of each string that are selected to be read. Thereby placing the current encoded stored data values of the row of selected memory cells on the column bit lines. A column page of bit lines is selected and sensed, and then individual data words are selected from the sensed data words from the column page and communicated from the Flash memory.

Because all the cells in an erase block of a Flash memory device must be erased at once, one cannot directly rewrite a Flash memory cell without first engaging in a block erase operation. Erase block management (EBM), which can be under the control of an internal state machine of the memory device or part of the driver software/memory controller, provides an abstraction layer for this to the host (typically a processor or an external memory controller), allowing the Flash device to appear as a freely rewriteable device. EBM duties also include, but are not limited to, managing the logical address to physical erase block translation mapping for reads and writes, the assignment of erased and available erase blocks for utilization, and the scheduling erase blocks that have been used and closed out for block erasure. Erase block management also allows for load leveling of the internal floating gate memory cells to help prevent write fatigue failure. Write fatigue is where the floating gate memory cell, after repetitive writes and erasures, no longer properly erases and removes charge from the floating gate. Load leveling procedures increase the mean time between failure of the erase block and Flash memory device as a whole.

The software routines and drivers that operate computer based devices and memory controllers are sometimes referred to as firmware or ROM after the non-volatile ROM machine-usable storage device that such routines have historically been stored in. It is noted that firmware or software routines can be stored on a variety of machine-usable storage mediums or firmware storage mediums that include, but are not limited to, a non-volatile Flash memory, a ROM, an EEPROM, a one time programmable (OTP) device, a complex programmable logic device (CPLD), an application specific integrated circuit (ASIC), a magnetic media disk, etc.

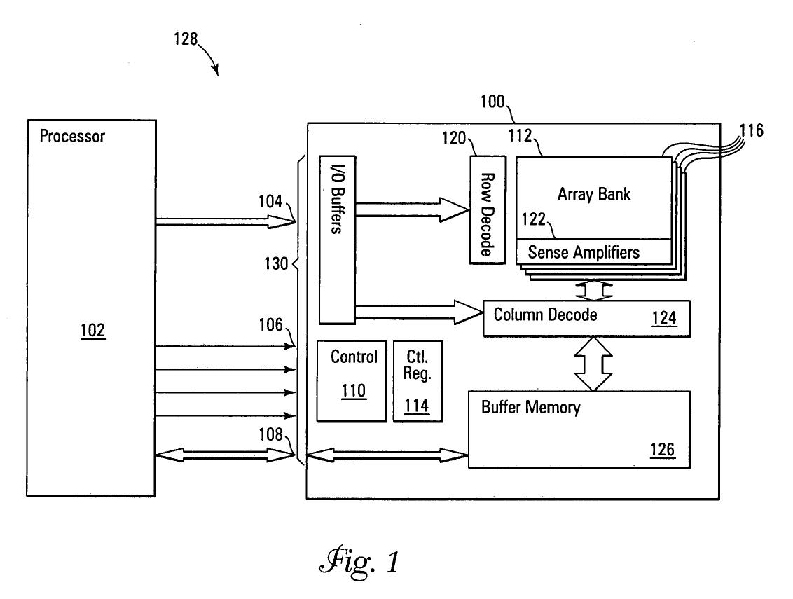

FIG. 1 shows a simplified diagram of a system 128 incorporating a NAND architecture Flash memory device 100 of the present invention coupled to a host 102, which is typically a processing device or memory controller. It is noted that memory device 100 embodiments of the present invention incorporating other non-volatile memory arrays 112 of differing technology and architecture types (including, but not limited to, Polymer Memory, FeRAM, OUM, MRAM, Molecular Memory, and Carbon Nanotube Memory) are also possible and should be apparent to those skilled in the art with the benefit of the present disclosure. The NAND architecture Flash memory device 100 has a synchronous interface 130 that contains an address interface 104, control interface 106, and data interface 108 that are each coupled to the processing device 102 to allow synchronous memory read and write accesses. Internal to the NAND architecture Flash memory device, an internal memory controller 110 directs the internal operation; managing the Flash memory array 112 and updating RAM control registers and non-volatile erase block management registers 114. The RAM control registers and tables 114 are utilized by the internal memory controller 110 during operation of the Flash memory device 100. The NAND architecture Flash memory array 112 contains a sequence of memory banks or segments 116. Each bank 116 is organized logically into a series of erase blocks (not shown). Memory access addresses are received on the address interface 104 of the NAND architecture Flash memory device 100 and divided into a row and column address portions. On a read access the row address is latched and decoded by row decode circuit 120, which selects and activates a row page (not shown) of memory cells across a selected memory bank, the memory cells of the strings associated with the selected row page are also activated in a pass-through mode. The bit values encoded in the output of the selected row of memory cells are coupled to a local bitline (not shown) and a global bitline (not shown) and are detected by sense amplifiers 122 associated with the memory bank. The column address of the access is latched and decoded by the column decode circuit 124. The output of the column decode circuit 124 selects the desired column data from the internal data bus (not shown) that is coupled to the outputs of the individual read sense amplifiers 122 and couples them to an internal buffer memory 126 for transfer from the memory device 100 through the data interface 108. On a write access the row decode circuit 120 selects the row page and column decode circuit 124 selects write sense amplifiers 122. Data values to be written are coupled from the buffer 126 via the internal data bus to the write sense amplifiers 122 selected by the column decode circuit 124 and written to the selected floating gate memory cells (not shown) of the memory array 112. The written cells are then reselected by the row and column decode circuits 120, 124 and sense amplifiers 122 so that they can be read to verify that the correct values have been programmed into the selected memory cells.

As stated above, the internal memory controller 110 controls operation of the NAND architecture Flash memory device 100 and through the synchronous interface 130 presents the NAND architecture Flash memory device 100 as a conventional synchronous memory (SDRAM, DDR, DDR 2, GDDR, RDRAM, etc.). The internal memory controller 110 also controls the specialized Flash memory interfacing and interaction with the memory array 112, including, but not limited to, accessing the memory array 112, address abstraction, mapping bad blocks, generating and evaluating ECCs, erase block management, wear leveling, block erasure, and writing data and/or files to the memory array 112. This allows the host 102 to interface to the NAND architecture Flash memory device 100 as if it was a conventional synchronous memory device and not require the use of external memory drivers or expensive dedicated external hardware. Additionally, the internal memory controller 110 allows ECC codes to be evaluated and generated in a fast and efficient manner via firmware run on the internal memory controller 110 or on dedicated internal ECC hardware, offloading the task from the host. This ECC generation in internal firmware/hardware is beneficial, in particular, where the NAND memory array includes multi-level memory cells (MLCs) that store multiple data bits in a single cell, further increasing the memory array 112 density but also increasing the ECC overhead to require the use of dedicated ECC generation in either the memory controller 110 firmware or in specialized ECC hardware.

The internal buffer memory 126 operates in concert with the memory controller 110 buffering data reads and writes, allowing the NAND architecture Flash memory device 100 to be presented as a synchronous memory device that has fast random read/write and/or burst capabilities. During a read access, the internal memory buffer 126 buffers the slow accessing Flash array 112 and stores its large data retrievals in the internal buffer memory 126 to be read from the Flash memory device 100. The buffer 126 acts as a cache memory and allows for fast random access of small data words and blocks from the data stored within its cached contents, after an initial delay period where the selected data is retrieved from the Flash memory array 112. In burst access mode the buffer 126 can also allow new data to be retrieved from the memory array 112, while the current data words stored in buffer 126 are being read. During a write access, the internal buffer memory 126 buffers the incoming data to be written to the Flash memory array 112, allowing data to be sent to the memory device 100 as fast as the host 102 can transfer it through the synchronous interface 130; the host 102 does not have to pause its transfer and wait while data is written/programmed into the Flash memory array 112.

As the buffer 126 acts as a cache memory, its size and/or manner of operation can be tailored to the access usage of the NAND architecture Flash memory device 100 by the host 102. This allows for an as efficient data access as possible given the expected data usage of the memory device 100. For example, the memory device 100 can be tailored for small data/block accesses, sequential data accesses, large data/block access, and so on. For random reads and/or writes, caching data management/replacement methods, including, but not limited to, translation look aside buffers, least recently used (LRU) data word replacement, and write-through caching, can also be used to great effect. In one embodiment of the present invention, a special purpose “ready/busy” external connection pin or internal status register/flag of the NAND architecture Flash memory device 100 may be monitored to indicate the status of the memory. This allows the memory device 100 to signal that it is busy with a read or write access (due to read or write latency, etc.), and causes the host 102 to wait, halting data transfers when active or set.

With large data write accesses/bursts to the NAND architecture Flash memory device 100, the internal data buffer 126 may run the risk of being filled and be unable to accept further data until some or all of the buffered data has been written the Flash memory array 112. This issue can be accommodated through tailoring the use of the Flash memory device 100 by the host 102 so that the data written at any one time does not exceed the size of the internal buffer memory 126. For example, tailoring/limiting intermittent written data to pieces that are within the size limit imposed by the internal buffer memory 126, or monitoring flow of data writes to the NAND architecture Flash memory device 100 so that if X data words are written in Y time the host 102 will hold off writing data to allow the Flash memory device 100 to write data to the Flash memory array 112 and the buffer memory 126 to clear, where X and Y are determined by the size of the internal data buffer 126 and the data write speed of the Flash memory device 100. Alternatively, the special purpose “ready/busy” external connection pin or internal status register/flag of the NAND architecture Flash memory device 100 may be monitored, which causes the host 102 to wait, halting data transfers when active or set.

This internal buffering by the internal buffer memory 126 allows the synchronous NAND architecture Flash memory device 100 to present a wholly compatible synchronous interface 130 to the host (such as a SDRAM or a DDR interface). This allows the NAND architecture Flash memory device 100 to be operated as if it was a compatible synchronous memory device (for example, a SDRAM or DDR-SDRAM) without special purpose software drivers or controller hardware and eliminates the need for separate shadow RAM in the system 128.

Embodiments of the present invention allow for code from the NAND architecture Flash memory device 100 to be executed in place after the requested data has been retrieved from the Flash memory array 112 and placed in the internal buffer 126 for access. This also allows for the system 128 to boot directly from NAND architecture Flash memory devices 100 of the present invention without the need for a separate boot device or a dedicated boot interface in the Flash memory device 100 (typically in the form of a dedicated first block address pin(s) for NAND Flash memory).

As stated above, it is noted that memory device 100 embodiments of the present invention incorporating other non-volatile memory arrays 112 of differing technology and architecture types (including, but not limited to, Polymer Memory, FeRAM, OUM, MRAM, Molecular Memory, and Carbon Nanotube Memory) are also possible and should be apparent to those skilled in the art with the benefit of the present disclosure.

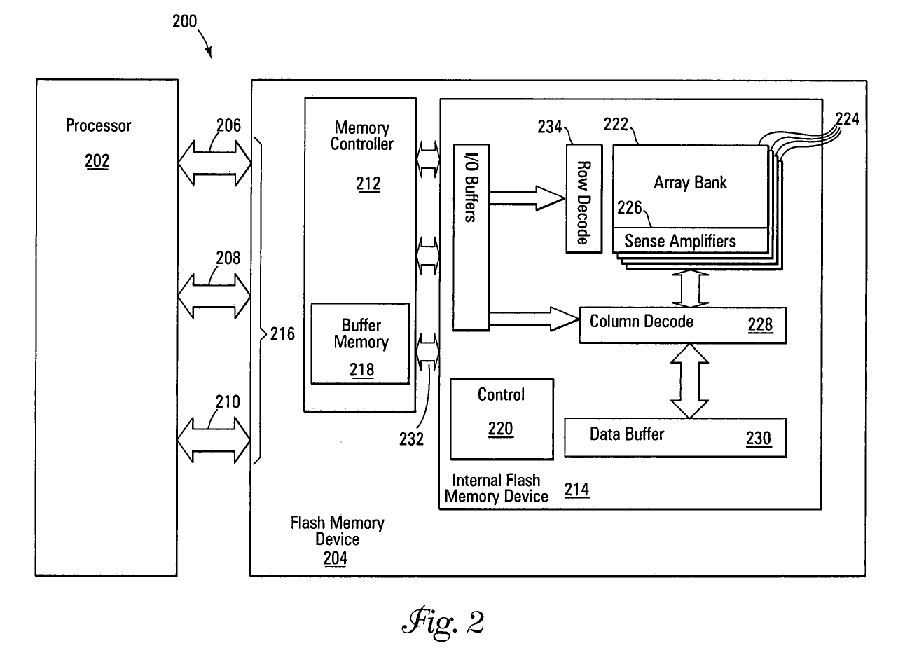

FIG. 2 is a simplified diagram of another system 200 that incorporates a NAND architecture Flash memory device 204 of an embodiment of the present invention. In the system 200 of FIG. 2, the Flash memory device 204 is coupled to a processor or host 202 with a synchronous interface 216 having an address 206, control 208, and data bus 210. It is noted that system 200 embodiments of the present invention incorporating other non-volatile memory devices 204 of differing technology and architecture types (including, but not limited to, Polymer Memory, FeRAM, OUM, MRAM, Molecular Memory, and Carbon Nanotube Memory) are also possible and should be apparent to those skilled in the art with the benefit of the present disclosure. Internal to the NAND architecture Flash memory device 204, a separate memory controller 212 having a buffer memory 218 is coupled to an internal NAND architecture Flash memory device 214 via its memory interface 232 (such as within a multi-chip module (MCM) package) and directs its operation. The separate memory controller 212 presents the internal NAND architecture Flash memory device 214 as a read/write synchronous memory device to the processor 202 and manages the internal NAND architecture Flash memory device 214; controlling the specialized Flash memory interfacing and interaction with the NAND architecture Flash memory device 214, including, but not limited to, accessing the NAND architecture Flash memory device 214, address abstraction, mapping bad blocks, generating and evaluating ECCs, erase block management, wear leveling, block erasure, and writing data and/or files to the NAND architecture Flash memory device 214. This allows the host 202 to interface to the NAND architecture Flash memory device 204 as if it was a conventional synchronous memory device and not require the use of external memory drivers or expensive dedicated external hardware. Additionally, the memory controller 212 allows ECC codes to be evaluated and generated in a fast and efficient manner via firmware or internal ECC hardware, offloading the task from the host. The memory controller 212 includes or is coupled to an internal buffer memory 218 for use in buffering data accesses to and from the NAND architecture Flash memory device 214. The internal buffer memory 218 operates in concert with the memory controller 212 buffering data reads and writes, allowing the NAND architecture Flash memory device 204 to be presented as a synchronous memory device that has fast random read/write and/or burst capabilities. This allows read/write buffering to the slow NAND architecture Flash memory device 214 and allows for in-place code execution from the NAND architecture Flash memory device 204.

The internal NAND architecture Flash device 214 includes a controller 220 that directs its internal operation; managing the Flash memory array 222 and updating RAM control registers and non-volatile erase block management registers (not shown). The NAND architecture Flash memory array 222 contains a sequence of memory banks or segments 224. Each bank 224 is organized logically into a series of erase blocks (not shown). Memory access addresses are received on the address interface of the internal NAND architecture Flash memory device 214 and divided into a row and column address portions. On a read access the row address is latched and decoded by row decode circuit 234, which selects and activates a row page (not shown) of memory cells across a selected memory bank, the memory cells of the strings associated with the selected row page are also activated in a pass-through mode. The bit values encoded in the output of the selected row of memory cells are coupled to a local bitline (not shown) and a global bitline (not shown) and are detected by sense amplifiers 226 associated with the memory bank. The column address of the access is latched and decoded by the column decode circuit 228. The output of the column decode circuit 228 selects the desired column data from the internal data bus (not shown) that is coupled to the outputs of the individual read sense amplifiers 226 and couples them to a data buffer 230 for transfer from the internal Flash memory device 214 to the buffer memory 218. On a write access the row decode circuit 234 selects the row page and column decode circuit 228 selects write sense amplifiers 226. Data values to be written are coupled from the buffer memory 218 via the data buffer 230 to the write sense amplifiers 226 selected by the column decode circuit 228 and written to the selected floating gate memory cells (not shown) of the memory array 222. The written cells are then reselected by the row and column decode circuits 234, 228 and sense amplifiers 226 so that they can be read to verify that the correct values have been programmed into the selected memory cells.

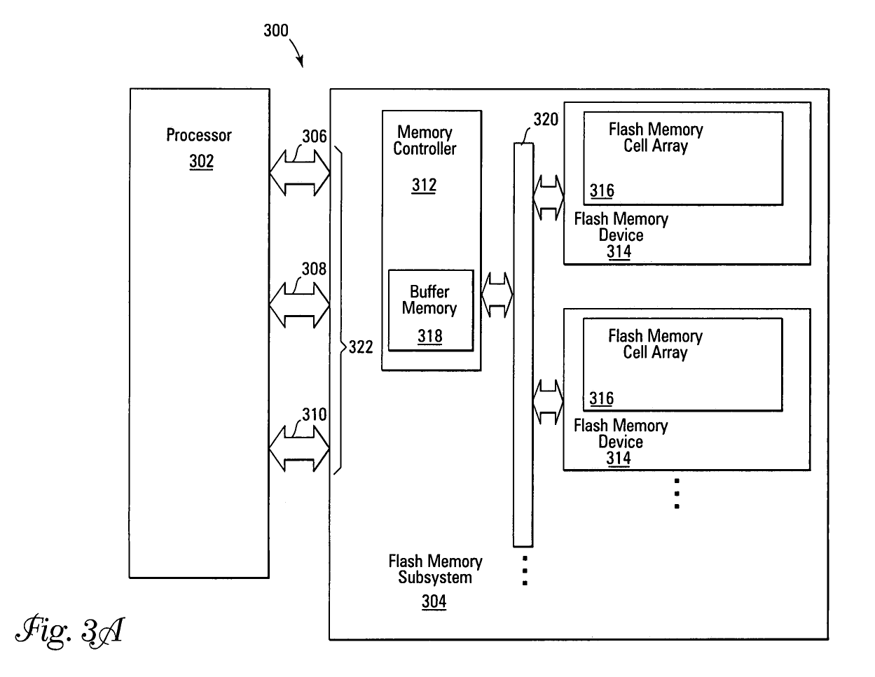

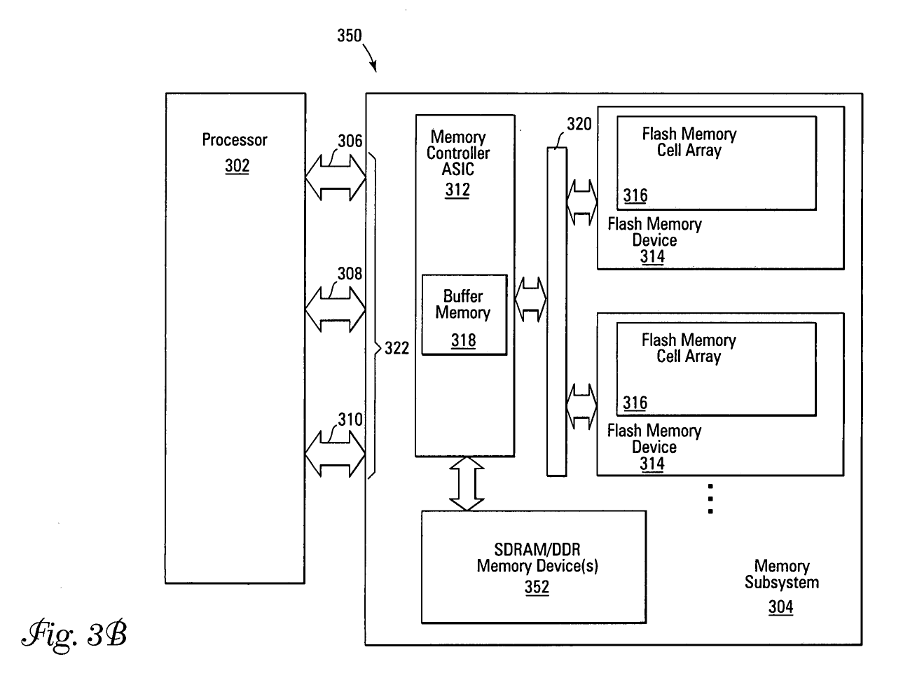

FIG. 3A is a simplified diagram of a system 300 that incorporates a NAND architecture Flash memory subsystem 304 of an embodiment of the present invention. In the system 300 of FIG. 3A, the Flash memory subsystem 304, such as a dedicated Flash memory subsystem or Flash memory card having one or more NAND architecture Flash memory devices 314 internal to it, is coupled to a processor or host 302 with a synchronous interface 322 having an address 306, control 308, and data bus 310. Internal to the Flash memory system 300, the memory controller 312 controls operation of the NAND architecture Flash memory subsystem 304 and through the synchronous interface 322 presents the NAND architecture Flash memory subsystem 304 as a conventional synchronous memory device (SDRAM, DDR, etc.). The memory controller 312 is coupled to and controls one or more NAND architecture Flash memory devices 314 via an internal bus 320; controlling the specialized Flash memory interfacing and interaction with the one or more NAND architecture Flash memory devices 314, including, but not limited to, accessing the NAND architecture Flash memory devices 314, address abstraction, mapping bad blocks, generating and evaluating ECCs, erase block management, wear leveling, block erasure, writing data and/or files to the NAND architecture Flash memory devices 314, and/or directing operation of other possible systems (not shown) of the Flash memory subsystem 304. This allows the host 302 to interface to the NAND architecture Flash memory subsystem 304 as if it was a conventional synchronous memory device and not require the use of external memory drivers or expensive dedicated external hardware. Additionally, the memory controller 312 allows ECC codes to be evaluated and generated in a fast and efficient manner via firmware or internal ECC hardware, offloading the task from the host. The memory controller 312 includes or is coupled to an internal buffer memory 318 for use in buffering data accesses to and from the NAND architecture Flash memory devices 314. The internal buffer memory 318 operates in concert with the memory controller 312 buffering data reads and writes, allowing the NAND architecture Flash memory subsystem 304 to be presented as a synchronous memory device that has fast random read/write and/or burst capabilities. This allows read/write buffering to the slow NAND architecture Flash memory devices 314 and allows for in-place code execution from the NAND architecture Flash memory subsystem 304.

FIG. 3B is another simplified diagram of a system 350 that incorporates a NAND architecture Flash memory subsystem 304 of an embodiment of the present invention. As with the system 300 of FIG. 3A, the system 350 of FIG. 3B details a Flash memory subsystem 304, such as a dedicated Flash memory subsystem or Flash memory card having one or more NAND architecture Flash memory devices 314 internal to it, is coupled to a processor or host 302 with a synchronous interface 322 having an address 306, control 308, and data bus 310. Internal to the Flash memory system 350, the memory controller 312 controls operation of the NAND architecture Flash memory subsystem 304 and through the synchronous interface 322 presents the NAND architecture Flash memory subsystem 304 as a conventional synchronous memory device (SDRAM, DDR, etc.). The memory controller 312 is coupled to and controls one or more NAND architecture Flash memory devices 314 via an internal bus 320; controlling the specialized Flash memory interfacing and interaction with the one or more NAND architecture Flash memory devices 314, including, but not limited to, accessing the NAND architecture Flash memory devices 314, address abstraction, mapping bad blocks, generating and evaluating ECCs, erase block management, wear leveling, block erasure, writing data and/or files to the NAND architecture Flash memory devices 314, and/or directing operation of other possible systems (not shown) of the Flash memory subsystem 304. This allows the host 302 to interface to the NAND architecture Flash memory subsystem 304 as if it was a conventional synchronous memory device and not require the use of external memory drivers or expensive dedicated external hardware.

Additionally, in the system 350 of FIG. 3B, a conventional synchronous DRAM 352 (such as a SDRAM, DDR, etc) is provided and coupled to a second memory interface of the memory controller 312. In another embodiment, the synchronous DRAM 352 is coupled to the memory controller 312 via the internal bus 320. The synchronous DRAM 352 is utilized by the memory controller 312 to allow an increased access speed to the NAND architecture Flash memory subsystem 304. In one embodiment, the synchronous DRAM 352 is selectively switched on to the synchronous interface 322 by the memory controller 312 to act as a “scratch pad” memory for the host 302 and decrease read and write latency of the memory system 304 when rapidly changing multiple reads and writes of the memory system occur (such as variable updating by a program). In another embodiment, the synchronous DRAM is utilized by the memory controller 312 as an extended cache/buffer memory area, allowing more data to be quickly stored or cached locally without having to access the NAND architecture Flash memory devices 314 in writing to or reading from the memory system 304. In yet another embodiment, the data contents held in sections of the NAND architecture Flash memory devices 314 are copied to the synchronous DRAM and the addresses of the sections of the NAND architecture Flash memory devices 314 remapped by the memory controller 312 to reference the synchronous DRAM 352, such that the synchronous DRAM 352 “shadows” the original sections of the NAND architecture Flash memory devices 314 remapped to it until any changes are written back to the NAND architecture Flash memory devices 314. These synchronous DRAM 352 containing embodiments of the present invention allow for an increase the operational speed of the memory system 304, allows for increased read/write buffering to the slow NAND architecture Flash memory devices 314, and allows for improved/larger in-place code execution from the NAND architecture Flash memory subsystem 304.

It is noted that memory system 300, 350 embodiments of the present invention detailed in FIGS. 3A and 3B incorporating other non-volatile memory subsystems 304 of differing technology and architecture types (including, but not limited to, Polymer Memory, FeRAM, OUM, MRAM, Molecular Memory, and Carbon Nanotube Memory) are also possible and should be apparent to those skilled in the art with the benefit of the present disclosure.

It is also noted that other architectures of high density non-volatile memory systems, external synchronous interfaces, and manners of coupling the memory controller to the high density non-volatile memory devices, such as directly coupled individual control busses and signal lines, are possible and should be apparent to those skilled in the art with benefit of the present disclosure. It is also noted that other formats and pairings of high density non-volatile memory devices or other non-volatile memory devices in a memory subsystem or memory device are possible and should be apparent to those skilled in the art with benefit of the present disclosure.

It is further noted that other synchronous high density non-volatile memory embodiments of the present invention incorporating buffer memory and internal memory controllers are possible and should be apparent to those skilled in the art with the benefit of the present invention.

### CONCLUSION

A high density non-volatile memory system, card, and device has been described that incorporates a synchronous interface and presents itself as a conventional synchronous RAM memory device. This is accomplished through use of an external or embedded controller and/or memory buffer to manage the high density non-volatile memory device(s) to present it as a conventional memory device having a synchronous interface. This allows the high density non-volatile memory embodiments of the present invention to support in-place code execution and allow them to be booted from. Additionally, the memory buffer allows for caching/buffering of data read and/or write accesses, allowing high density non-volatile memory devices of the present invention to be quickly accessed as if they were conventional synchronous RAM memory devices. In one embodiment of the present invention, a high density non-volatile memory device eliminates the requirement of external drivers and/or operating system support to utilize a high density non-volatile memory device, and in particular, a NAND architecture Flash memory device. This simplifies the use and design effort of high density non-volatile memories by reducing specialized interfacing, while reducing the overall production cost through allowing use of a less expensive high density non-volatile memory or NAND architecture Flash memory where a more expensive memory device would normally be required. In another embodiment of the present invention, a NAND architecture Flash card or subsystem has a synchronous interface. In a further embodiment of the present invention, a NAND architecture Flash memory device, card, or subsystem has an SDRAM compatible interface. In yet a further embodiment of the present invention, individual data words of a NAND architecture Flash memory device, card, or subsystem may be accessed in a non-prohibitive manner. In another embodiment of the present invention, a NAND architecture Flash memory device, card, or subsystem is accessed by a row and column address. In yet another embodiment of the present invention, a NAND architecture Flash memory device, card, or subsystem contains a RAM buffer allowing in-place code execution and/or read/write access.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A non-volatile memory device comprising:
a non-volatile memory array;
a buffer memory;
a synchronous memory interface; and
a controller coupled to the non-volatile memory array, the buffer memory, and the synchronous memory interface, wherein the controller is adapted to interface to and manage the non-volatile memory array and buffer memory and to present the non-volatile memory device as a synchronous memory device through the synchronous memory interface.

2. The non-volatile memory device of claim 1, wherein the controller is adapted to buffer data accesses to the non-volatile memory array in the buffer memory.

3. The non-volatile memory device of claim 2, wherein the controller is adapted to buffer read data accesses to the non-volatile memory array in the buffer memory.

4. The non-volatile memory device of claim 3, wherein the controller is adapted to buffer read data accesses to the non-volatile memory array in the buffer memory in a least recently used manner.

5. The non-volatile memory device of claim 3, wherein the controller is adapted to buffer a current data block to the non-volatile memory array in the buffer memory while accessing a sequentially following data block from the non-volatile memory array.

6. The non-volatile memory device of claim 2, wherein the controller is adapted to buffer write data accesses to the non-volatile memory array in the buffer memory.

7. The non-volatile memory device of claim 6, wherein the controller is adapted to buffer write data accesses to the non-volatile memory array in the buffer memory in a write-through manner.

8. The non-volatile memory device of claim 6, wherein the non-volatile memory device is adapted to indicate when the non-volatile memory device is busy by changing the status of one of an external “ready/busy” pin and a status register.

9. The non-volatile memory device of claim 8, wherein the non-volatile memory device is adapted to indicate when the buffer memory is full during a write access by asserting one of an external “ready/busy” pin and a status register.

10. The non-volatile memory device of claim 1, wherein the non-volatile memory device is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

11. The non-volatile memory device of claim 1, wherein the synchronous interface is one of a SDRAM interface, a DDR interface, a DDR2 interface, GDDR interface, GDDR2 interface, and RDRAM interface.

12. The non-volatile memory device of claim 1, wherein the non-volatile memory is adapted to present as one of a compatible read/write capable SDRAM device, a DDR device, a DDR2 device, a GDDR device, a GDDR2 device, and a RDRAM device.

13. The non-volatile memory device of claim 1, wherein the non-volatile memory device is a BIOS boot memory.

14. The non-volatile memory device of claim 1, wherein the non-volatile memory is adapted to have a burst data access mode.

15. The non-volatile memory device of claim 1, wherein the controller is adapted to generate and evaluate ECC data.

16. The non-volatile memory device of claim 15, wherein the controller is adapted to generate and evaluate ECC data in an ECC hardware circuit.

17. The non-volatile memory device of claim 1, further comprising:
a DRAM memory array coupled to the controller.

18. The non-volatile memory device of claim 17, wherein the controller is adapted to selectively couple the DRAM memory array to the synchronous memory interface.

19. The non-volatile memory device of claim 17, wherein the controller is adapted to selectively copy data from the non-volatile memory array and remap addresses of one or more DRAM memory array section to the synchronous memory interface to operate as “shadow” memory.

20. The non-volatile memory device of claim 17, wherein the controller is adapted to operate the DRAM memory array as an extended read and/or write data buffer memory.

21. The non-volatile memory device of claim 17, wherein the controller is adapted to operate the DRAM memory array as “scratch pad” memory.

22. A NAND architecture Flash memory device comprising:
a NAND architecture Flash memory array;
a buffer memory;
a synchronous memory interface; and
a controller coupled to the NAND architecture Flash memory array, the buffer memory, and the synchronous memory interface, wherein the controller is adapted to interface to and manage the NAND architecture Flash memory array and to portray the NAND architecture Flash memory device as a synchronous memory device through the synchronous memory interface.

23. The NAND architecture Flash memory device of claim 22, wherein the controller is adapted to buffer data accesses to the NAND architecture Flash memory array in the buffer memory.

24. The NAND architecture Flash memory device of claim 23, wherein the controller is adapted to buffer read data accesses to the NAND architecture Flash memory array in the buffer memory.

25. The NAND architecture Flash memory device of claim 24, wherein the controller is adapted to buffer read data accesses to the NAND architecture Flash memory array in the buffer memory in a least recently used manner.

26. The NAND architecture Flash memory device of claim 23, wherein the controller is adapted to buffer write data accesses to the NAND architecture Flash memory array in the buffer memory.

27. A non-volatile memory subsystem comprising:
one or more non-volatile memory devices;
a buffer memory;
a synchronous memory interface; and
a controller coupled to the one or more non-volatile memory devices, the buffer memory, and the synchronous memory interface, wherein the controller is adapted to interface to and manage the non-volatile memory devices and to present the non-volatile memory devices as a synchronous memory device through the synchronous memory interface.

28. The non-volatile memory subsystem of claim 27, wherein at least one of the one or more non-volatile memory devices is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

29. The non-volatile memory subsystem of claim 27, wherein the controller is adapted to buffer data accesses to the one or more non-volatile memory devices in the buffer memory.

30. The non-volatile memory subsystem of claim 29, wherein the controller is adapted to buffer read data accesses to the one or more non-volatile memory devices in the buffer memory.

31. The non-volatile memory subsystem of claim 29, wherein the controller is adapted to buffer write data accesses to the one or more non-volatile memory devices in the buffer memory.

32. The non-volatile memory subsystem of claim 29, wherein the non-volatile memory subsystem is adapted to indicate when the non-volatile memory subsystem is busy by changing the status of one of an external “ready/busy” pin and a status register.

33. The non-volatile memory subsystem of claim 31, wherein the non-volatile memory subsystem is adapted to indicate when the buffer memory is full during a write access by asserting one of an external “busy” pin and a status register.

34. The non-volatile memory subsystem of claim 27, wherein the synchronous interface is one of a SDRAM interface, a DDR interface, a DDR2 interface, GDDR interface, GDDR2 interface, and RDRAM interface.

35. The non-volatile memory subsystem of claim 27, wherein the non-volatile memory subsystem is adapted to present as one of a compatible read/write capable SDRAM device, a DDR device, a DDR2 device, a GDDR device, a GDDR2 device, and a RDRAM device.

36. The non-volatile memory subsystem of claim 27, wherein the non-volatile memory subsystem is adapted to have a burst data access mode.

37. The non-volatile memory subsystem of claim 27, wherein the controller is adapted to generate and evaluate ECC data.

38. The non-volatile memory subsystem of claim 37, wherein the controller further comprises:
an ECC hardware circuit coupled to the one or more non-volatile memory devices.

39. The non-volatile memory subsystem of claim 27, further comprising:
one or more synchronous DRAM memory devices coupled to the controller.

40. The non-volatile memory subsystem of claim 39, wherein the controller is adapted to selectively couple the one or more synchronous DRAM memory devices to the synchronous memory interface.

41. The non-volatile memory subsystem of claim 39, wherein the controller is adapted to selectively copy data from the one or more non-volatile memory devices and remap addresses of the one or more synchronous DRAM memory devices to the synchronous memory interface to operate as “shadow” memory.

42. The non-volatile memory subsystem of claim 39, wherein the controller is adapted to operate the one or more synchronous DRAM memory devices as an extended read and/or write data buffer memory.

43. The non-volatile memory subsystem of claim 39, wherein the controller is adapted to operate the one or more synchronous DRAM memory devices as “scratch pad” memory.

44. The non-volatile memory subsystem of claim 39, wherein the one or more synchronous DRAM memory devices are one of SDRAM device, a DDR device, a DDR2 device, a GDDR device, a GDDR2 device, and a RDRAM device.

45. A system comprising:
a host; and
one or more non-volatile memory devices coupled to the host, wherein each of the
one or more non-volatile memory devices comprises,
a non-volatile memory array;
a buffer memory;
a synchronous memory interface; and
a controller coupled to the non-volatile memory array, the buffer memory, and the synchronous memory interface, wherein the controller is adapted to interface to and manage the non-volatile memory array and to present the non-volatile memory device as a synchronous memory device through the synchronous memory interface.

46. The system of claim 45, wherein at least one of the one or more non-volatile memory devices is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

47. The system of claim 45, wherein the controller of each non-volatile memory device is adapted to buffer data accesses to the non-volatile memory array in the buffer memory.

48. The system of claim 47, wherein the controller is adapted to buffer read data accesses to the non-volatile memory array in the buffer memory.

49. The system of claim 47, wherein the controller is adapted to buffer write data accesses to the non-volatile memory array in the buffer memory.

50. The system of claim 47, wherein each non-volatile device is adapted to indicate when the non-volatile memory device is busy by changing the status of one of an external “ready/busy” pin and a status register.

51. The system of claim 49, wherein each non-volatile memory device is adapted to indicate when the buffer memory is full during a write access by changing the status of one of an external “ready/busy” pin and a status register.

52. The system of claim 45, wherein the synchronous interface of each non-volatile memory device is one of a SDRAM interface, a DDR interface, a DDR2 interface, GDDR interface, GDDR2 interface, and RDRAM interface.

53. The system of claim 45, wherein each non-volatile memory device is adapted to present as one of a compatible read/write capable SDRAM device, a compatible read/write capable DDR device, a compatible read/write capable DDR2 device, a compatible read/write capable GDDR device, a compatible read/write capable GDDR2 device, and a compatible read/write capable RDRAM device.

54. The system of claim 45, wherein at least one non-volatile memory device is a boot memory.

55. The system of claim 45, wherein each non-volatile memory device further comprises:
a DRAM memory array coupled to the controller.

56. The system of claim 55, wherein the controller is adapted to selectively couple the DRAM memory array to the synchronous memory interface.

57. The system of claim 55, wherein the controller is adapted to selectively copy data from the non-volatile memory array and remap addresses of one or more DRAM memory array section to the synchronous memory interface to operate as “shadow” memory.

58. The system of claim 55, wherein the controller is adapted to operate the DRAM memory array as an extended read and/or write data buffer memory.

59. The system of claim 55, wherein the controller is adapted to operate the DRAM memory array as “scratch pad” memory.

60. A method of operating a non-volatile memory device comprising:
managing the non-volatile memory device with an internal controller;
presenting the non-volatile memory device as a synchronous memory device through a synchronous memory interface; and
buffering data access requests received through the synchronous memory interface in an internal buffer memory.

61. The method of claim 60, wherein the non-volatile memory device is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

62. The method of claim 60, wherein buffering data access requests received through the synchronous memory interface in an internal buffer memory further comprises buffering read data access requests in the internal buffer memory.

63. The method of claim 60, wherein presenting the non-volatile memory device as a synchronous memory device through a synchronous memory interface further comprises changing the status of one of an external “ready/busy” pin and a status register to indicate that the non-volatile memory device is busy.

64. The method of claim 60, wherein buffering data access requests received through the synchronous memory interface in an internal buffer memory further comprises changing the status of one of an external “ready/busy” pin and a status register to indicate that the non-volatile memory device is busy.

65. The method of claim 60, wherein buffering data access requests received through the synchronous memory interface in an internal buffer memory further comprises buffering write data access requests in the internal buffer memory.

66. The method of claim 65, wherein buffering write data access requests received through the synchronous memory interface in an internal buffer memory further comprises asserting one of an external “busy” pin and a status register to indicate that the buffer memory is full during a write access.

67. The method of claim 60, wherein presenting the non-volatile memory device as a synchronous memory device through a synchronous memory interface further comprises presenting one of a SDRAM device, a DDR device, a DDR2 device, a GDDR device, a GDDR2 device, and a RDRAM device.

68. The method of claim 67, wherein presenting one of a SDRAM device, a DDR device, a DDR2 device, a GDDR device, a GDDR2 device, and a RDRAM device further comprises presenting as one of a compatible read/write capable SDRAM device, a compatible read/write capable DDR device, a compatible read/write capable DDR2 device, a compatible read/write capable GDDR device, a compatible read/write capable GDDR2 device, and a compatible read/write capable RDRAM device.

69. The method of claim 60, further comprising:
generating and evaluating ECC data for each data access request.

70. The method of claim 60, further comprising:
managing a DRAM memory array with the internal controller.

71. The method of claim 70, wherein presenting the non-volatile memory device as a synchronous memory device through a synchronous memory interface further comprises selectively presenting the DRAM memory array as a synchronous memory device through a synchronous memory interface.

72. The method of claim 70, wherein presenting the non-volatile memory device as a synchronous memory device through a synchronous memory interface further comprises selectively presenting the DRAM memory array as a synchronous memory device through a synchronous memory interface, where data is selectively copied from the non-volatile memory device and the corresponding addresses remapped to one or more internal addresses of one or more DRAM memory array sections to operate as “shadow” memory.

73. The method of claim 70, wherein buffering data access requests received through the synchronous memory interface in an internal buffer memory further comprises buffering data access requests received through the synchronous memory interface in the DRAM memory array as an extended read and/or write data buffer memory.

74. The method of claim 70, wherein selectively presenting the DRAM memory array as a synchronous memory device through a synchronous memory interface further comprises selectively presenting the DRAM memory array as a synchronous memory device through a synchronous memory interface, where the DRAM memory array operates as “scratch pad” memory.

75. A method of operating a NAND architecture Flash memory device comprising:
managing the NAND architecture Flash memory device with an internal controller;
presenting the NAND architecture Flash memory device as a synchronous memory device through a synchronous memory interface; and
buffering data access requests received through the synchronous memory interface in an internal buffer memory.

76. The method of claim 75, wherein buffering data access requests received through the synchronous memory interface in an internal buffer memory further comprises buffering read data access requests in the internal buffer memory.

77. The method of claim 75, wherein buffering data access requests received through the synchronous memory interface in an internal buffer memory further comprises changing the status of one of an external “ready/busy” pin and a status register to indicate that the non-volatile memory device is busy.

78. The method of claim 75, wherein buffering data access requests received through the synchronous memory interface in an internal buffer memory further comprises buffering write data access requests in the internal buffer memory.

79. A method of operating a non-volatile memory subsystem comprising:
managing one or more non-volatile memory devices with a controller;
presenting the one or more non-volatile memory devices as a synchronous memory device through a synchronous memory interface; and
buffering data access requests received through the synchronous memory interface in a buffer memory.

80. The method of claim 79, wherein at least one of the one or more non-volatile memory devices is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

81. The method of claim 79, wherein buffering data access requests received through the synchronous memory interface in an internal buffer memory further comprises buffering read data access requests in the internal buffer memory.

82. The method of claim 79, wherein presenting the one or more non-volatile memory devices as a synchronous memory device through a synchronous memory interface further comprises changing the status of one of an external “ready/busy” pin and a status register to indicate that the non-volatile memory device is busy.

83. The method of claim 79, wherein buffering data access requests received through the synchronous memory interface in an internal buffer memory further comprises changing the status of one of an external “ready/busy” pin and a status register to indicate that the non-volatile memory device is busy.

84. The method of claim 79, wherein buffering data access requests received through the synchronous memory interface in an internal buffer memory further comprises buffering write data access requests in the internal buffer memory.

85. The method of claim 84, wherein buffering write data access requests received through the synchronous memory interface in an internal buffer memory further comprises asserting one of an external “busy” pin and a status register to indicate that the buffer memory is full during a write access.

86. The method of claim 79, wherein presenting the one or more non-volatile memory devices as a synchronous memory device through a synchronous memory interface further comprises presenting one of a SDRAM memory device, a DDR memory device, a DDR2 memory device, a GDDR memory device, a GDDR2 memory device, and a RDRAM memory device.

87. The method of claim 86, wherein presenting one of a SDRAM memory device, a DDR memory device, a DDR2 memory device, a GDDR memory device, a GDDR2 memory device, and a RDRAM memory device further comprises presenting as one of a compatible read/write capable SDRAM memory device, a compatible read/write capable DDR memory device, a compatible read/write capable DDR2 memory device, a compatible read/write capable GDDR memory device, a compatible read/write capable GDDR2 memory device, and a compatible read/write capable RDRAM memory device.

88. The method of claim 79, further comprising:
generating and evaluating ECC data for each data access request.

89. The method of claim 79, further comprising:
managing one or more synchronous DRAM memory devices with the controller.

90. The method of claim 89, wherein presenting the one or more non-volatile memory devices as a synchronous memory device through a synchronous memory interface further comprises selectively presenting the one or more synchronous DRAM memory devices as a synchronous memory device through a synchronous memory interface.

91. The method of claim 89, wherein presenting the one or more non-volatile memory devices as a synchronous memory device through a synchronous memory interface further comprises selectively presenting the one or more synchronous DRAM memory devices as a synchronous memory device through a synchronous memory interface, where data is selectively copied from the one or more non-volatile memory devices and the corresponding addresses remapped to one or more internal addresses of the one or more DRAM memory devices to operate as “shadow” memory.

92. The method of claim 89, wherein buffering data access requests received through the synchronous memory interface in an internal buffer memory further comprises buffering data access requests received through the synchronous memory interface in the one or more DRAM memory devices as an extended read and/or write data buffer.

93. The method of claim 89, wherein selectively presenting the one or more DRAM memory devices as a synchronous memory device through a synchronous memory interface further comprises selectively presenting the one or more DRAM memory devices as a synchronous memory device through a synchronous memory interface, where the one or more DRAM memory devices operate as “scratch pad” memory.

94. A machine-usable medium, the machine-usable medium containing a software routine for causing a memory controller to execute a method, wherein the method comprises:
managing one or more non-volatile memory devices with the memory controller;
presenting one or more non-volatile memory devices as a synchronous memory device through a synchronous memory interface; and
buffering data access requests received through the synchronous memory interface in a buffer memory.

95. The system of claim 94, wherein at least one of the one or more non-volatile memory devices is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

96. A system comprising:
a host; and
one or more non-volatile memory devices coupled to the host, wherein each of the one or more non-volatile memory devices comprises,
a non-volatile memory array;
a buffer memory; and
a synchronous memory interface, wherein the non-volatile memory devices comprises a means for interfacing with, managing, and buffering data access to the non-volatile memory array and comprises a means for presenting the non-volatile memory device as a synchronous memory device through the synchronous memory interface.

97. The system of claim 96, wherein at least one of the one or more non-volatile memory devices is one of a NAND architecture Flash, a NOR architecture Flash, EEPROM, Polymer Memory, Ferroelectric Random Access Memory (FeRAM), Ovionics Unified Memory (OUM), Magnetoresistive Random Access Memory (MRAM), Molecular Memory, and Carbon Nanotube Memory.

98. A NAND architecture Flash memory subsystem comprising:
one or more NAND architecture Flash memory devices;
a buffer memory;
a synchronous memory interface; and
a controller coupled to the one or more NAND architecture Flash memory devices, the buffer memory, and the synchronous memory interface, wherein the controller is adapted to interface to and manage the NAND architecture Flash memory devices and to present the NAND architecture Flash memory devices as a synchronous memory device through the synchronous memory interface.

99. A method of operating a NAND architecture Flash memory subsystem comprising:
managing one or more NAND architecture Flash memory devices with a controller;
presenting the one or more NAND architecture Flash memory devices as a synchronous memory device through a synchronous memory interface; and
buffering data access requests received through the synchronous memory interface in a buffer memory.
